(19) United States
(12) Patent Application Publication
(10) Pub. No.: US 2015/0310753 A1
(43) Pub. Date: Oct. 29, 2015

(54) SYSTEMS AND METHODS FOR SPLIT TESTING EDUCATIONAL VIDEOS

(71) Applicant: KHAN ACADEMY, INC., MOUNTAIN VIEW, CA (US)

(72) Inventor: MATT FAUS, SUNNYVALE, CA (US)

(21) Appl. No.: 14/671,830

(22) Filed: Mar. 27, 2015

Related U.S. Application Data
(60) Provisional application No. 61/975,685, filed on Apr. 4, 2014.

(51) Int. Cl. G09B 7/00; G06F 17/30

(52) U.S. Cl. CPC G09B 7/00; G06F 17/3084

(57) ABSTRACT

Systems and methods are provided for comparing different videos pertaining to a topic. Two different versions of an educational video may be compared using split comparison testing. A set of questions may be provided along with each video about the topic taught in the video. Users may view one of the videos and answer the questions. Data about the user responses may be aggregated and used to determine which video more effectively conveys information to the viewer based on the question responses.

### CROSS-REFERENCE

This application claims the benefit of U.S. Provisional Application No. 61/975,685, filed Apr. 4, 2014, which application is incorporated herein by reference.

### BACKGROUND OF THE INVENTION

Educators often create videos to explain concepts to their students. Educators may want these videos to accomplish a goal of explaining these concepts in the most effective way possible. Students may provide feedback to the educators, who may then make changes to the videos. However, educators do not have a way of reliably measuring that the new version of the videos are indeed conveying the concepts more effectively than the previous versions.

A need exists for improved systems and method for determining whether one educational video is more effective than another.

### SUMMARY OF THE INVENTION

An aspect of the invention is directed to a method for comparing online educational videos, said method comprising: storing, in a memory, a first video about a topic including at least one question relating to content of the first video and a second video about the same topic including at least one question relating to content of the second video; receiving a first request for a video to be displayed on a first user interface and a second request for a video to be displayed on a second user interface; providing, in response to the first request, the first video, and providing, in response to the second request, the second video; receiving, information about a user response to the at least one question relating to the content of the first video and information about a user response to the at least one question relating to the content of the second video; and displaying, with aid of a processor, an analysis of the information about the user response to the at least one question relating to the content of the first video and the information about the user response to the at least one question relating to the content of the second video, thereby aiding in a determination of whether the first video conveys the topic more effectively or the second video conveys the topic more effectively.

Additional aspects of the invention may be directed to a system for comparing online educational videos, said system comprising: a memory configured to store a first video about a topic including at least one question relating to content of the first video and a second video about the same topic including at least one question relating to content of the second video; and one or more processors individually or collectively configured to: receive a first request for a video to be displayed on a first user interface and a second request for a video to be displayed on a second user interface; generate, in response to the first request, an instruction to provide the first video, and provide, in response to the second request, an instruction to provide the second video; receive, information about a user response to the at least one question relating to the content of the first video and information about a user response to the at least one question relating to the content of the second video; analyze the information about the user response to the at least one question relating to the content of the first video and the information about the user response to the at least one question relating to the content of the second video; and generate an instruction to show, on a display, the analysis of the information, thereby aiding in a determination of whether the first video conveys the topic more effectively or the second video conveys the topic more effectively.

Other goals and advantages of the invention will be further appreciated and understood when considered in conjunction with the following description and accompanying drawings. While the following description may contain specific details describing particular embodiments of the invention, this should not be construed as limitations to the scope of the invention but rather as an exemplification of preferable embodiments. For each aspect of the invention, many variations are possible as suggested herein that are known to those of ordinary skill in the art. A variety of changes and modifications can be made within the scope of the invention without departing from the spirit thereof.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 shows an example of videos that may be displayed on different user interfaces, in accordance with an embodiment of the invention.

FIG. 2 shows another example of videos that may be displayed on different user interfaces.

FIG. 3 shows examples of timelines indicating when questions may appear during a video's progress.

FIG. 4 shows an example of a configuration used to provide a question for a video.

FIG. 5 shows an example of a question displayed on a user interface.

FIG. 6 shows an example of data that may be collected and/or analyzed regarding responses to questions displayed with a video.

FIG. 7 shows another example of data that may be collected and/or analyzed regarding responses to questions displayed with a video.

FIG. 8 shows a system for a providing a video in accordance with an embodiment of the invention.

FIG. 9 shows an example of a computing device in accordance with an embodiment of the invention.

### DETAILED DESCRIPTION OF THE INVENTION

While preferred embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

The invention provides systems and methods for comparing educational videos. Various aspects of the invention described herein may be applied to any of the particular applications set forth below or for any other types of instructional systems. The invention may be applied as a standalone system or method, or as part of an integrated content management system. It shall be understood that different aspects of the invention can be appreciated individually, collectively, or in combination with each other.

Educators may create videos to explain concepts to their students. These videos may be lecture videos. The educators may wish for the videos to convey information in an effective a manner as possible so that the students can learn. In some instances, the educators may create multiple versions of videos and wish to compare how effectively the various versions enable students to learn.

An A/B split testing system may be used to compare video efficacy. Different versions of the videos may be shown to students. For example, some students may view a first version of the video while some other students may view a second version of the video. Both versions may pertain to the same topic. Both versions may attempt to convey the educational content in a different manner from one another. The students may be presented with questions relating to the content of the video. These questions may be displayed while the student is viewing the video or after the student has completed watching the video. In some instances, the questions may be overlaid onto the video. Optionally, the questions may be multiple choice questions.

The students may answer the questions and their responses may be analyzed. The students' answers may be aggregated and broken down for each of the video versions. The educator can then perform higher level analysis. For example, if one of the video versions yielded a higher percentage of correct answers, that video version may more effectively convey the content to the student. Other information, such as number of questions viewed, may be displayed and considered by the educator. In another example, the educator can view the results by question, which may show which video is more effectively conveying information on a question by question basis.

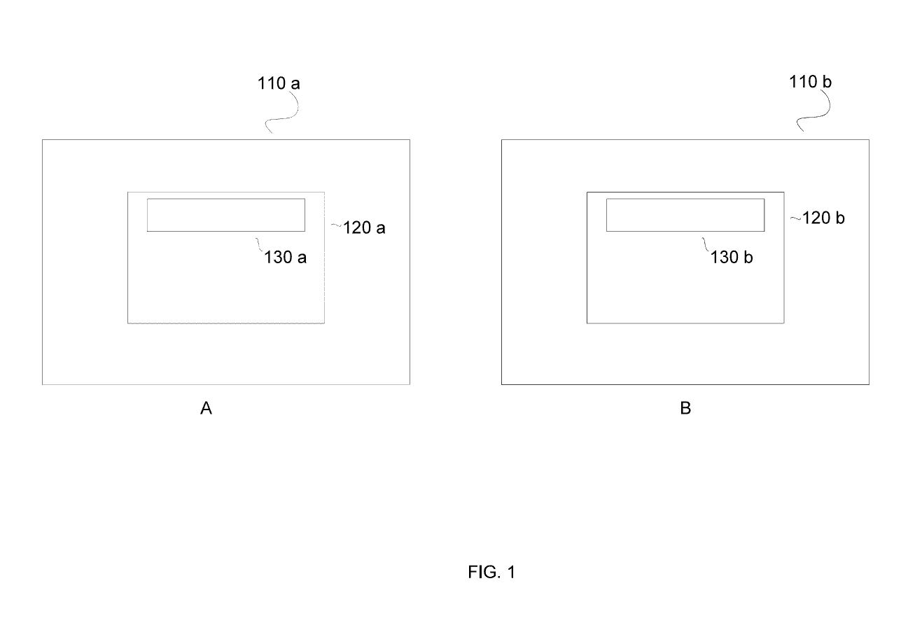

FIG. 1 shows an example of videos that may be displayed on different user interfaces, in accordance with an embodiment of the invention. A first user interface 110a and a second user interface 110b may be provided. A first video 120a may be displayed in the first user interface, and a second video 120b may be displayed in the second user interface. At one or more points in time, a question 130a may be displayed in the first user interface, and a question 130b may be displayed in the second user interface.

The user interfaces may be displayed on a device of a user. For example, a user may be an individual viewing a video. For example, the user may be a student, parent, educator, administrator, or any other individual desiring to view the video and/or learn content conveyed by the video. A device may be any type of device capable of displaying video. For example, the device may be a personal computer, laptop, tablet, smartphone, television, projection screen, or any other type of device, including those described elsewhere herein. The device may also be capable of conveying audio information.

In some instances, the user interface may display a web browser showing content to the user. In some instances, the user interface may display a screen from a software or application. The user interface may show a video. The video may be streaming video. For example, the video may be streaming from over the Internet. The video may be provided as part of a cloud service. The video may be stored off-board the user device In other examples, the videos may be pre-stored in memory on the user device. The video may be played from the memory of the user device and may be played from on-board the user device. In some instances, the user interface may display additional information in addition to the video. For example, additional text and/or images may be displayed with the video. In some instances multiple videos may be provided. The additional information may remain static while the video is playing or may be dynamic and change while the video is playing. The change or additional content may or may not be coordinated with the video's progress.

The video may be provided as part of an educational service. For example, the video content may include information on one or more topics. The video may be a lecture pertaining to the one or more topics. In some examples, the video may include an instructor speaking on the topic and/or one or more visual aid. The visual aids may include text, equations, images, animations, or video. The video may be of any topic including, but not limited to, mathematics, science, history, literature, art, sociology, philosophy, music, computer sciences, dance, engineering, journalism, medicine, law, business, or any other topic.

One or more questions may be displayed with the video. The questions may pertain to the content of the video. For example, the questions may be multiple choice questions, true/false questions, or other types of questions where a user may select an answer from a plurality of available answers. In some implementations, questions may be short-answer questions where the user may enter a word or phrase. The questions may be presented while the video is playing, or may be presented after the video has been completed. In some instances, one or more questions may be presented to a user before the video has started. The pre-video questions may be used to establish a baseline of the user's knowledge. The questions presented during the video and/or after the completion of the video may be used to assess what the user knows after watching the portion of the video or the entirety of the video. This may or may not be compared with the baseline of the user's knowledge to assess what the user has learned through the video. Any of the questions may pertain to the content of the video and/or the topic covered by the video.

Any number of questions may be displayed prior to showing the video. In some instances, zero, one, two, three, four or more questions are presented to a user prior to showing the video. Any number of questions may be shown while the video is playing. For example, zero, one, two, three, four or more questions may be presented to a user at any number of points of the video. Any number of questions may be shown after the video has finished playing. For example, zero, one, two, three, four or more questions may be presented to a user after the video has finished playing. The user responses to the questions may be stored. In some instances, the user may select an answer from a plurality of possible answers, or the user may choose to skip answering the question. These user responses (e.g., the selected answer and/or the user skipping the question) may be aggregated. The information of how many questions the user has viewed may also be aggregated. For example, some users may not watch the whole video and may never see some questions.

The questions may be displayed anywhere on the user interface. In one example, the question may be overlaid on the video. In some instances, the video may pause during its playback while the question is displayed over the video. The video may remain paused until the user selects an answer and/or selects an option to skip the question. In some instances, the question may remain visible until the user responds by selecting an answer or selecting an option to skip the question. In other instances, the question may remain visible for no longer than a predetermined period of time (e.g., 10 minutes or less, 5 minutes or less, 3 minutes or less, 2 minutes or less, 1 minute or less, 30 seconds or less, 15 seconds or less, 10 seconds or less). If the user does not respond in the predetermined period of time, the question may be deemed to be skipped. When the question is answered or skipped, the video may automatically resume playback. The questions may be overlaid on the video at desired points in time. The questions may be overlaid so that they pertain to the topic that was recently discussed in the video. In some instances, the video may have natural spaces where questions are meant to be inserted.

A video creator, such as an educator, may wish to compare different versions of the video. The video creator may be a lecturer appearing in the video, an aide or assistant of the lecturer, an administrator, or any other individual that may be involved in disseminating the content of the video.

In one example, an educator may share the content of a video. The educator may receive feedback on the video. The feedback may be provided by one or more individuals, such as students, or other educators. The educator may make changes to the video in response to the feedback. The original version of the video may be one version of the video, and the changed version of the video may be another version of the video. The educator may wish to compare these videos. The educator may do this any number of times (e.g., may elicit feedback from individuals any number of times, and create new versions of videos in response to the feedback). The educator may compare newer versions of videos with older versions of videos any number of times. Any number of versions may be compared. For example, two versions of videos may be compared, three versions of videos may be compared, four versions of videos may be compared, or more.

In another example, an educator may create multiple versions of a video from the outset. For example, the educator may have multiple ideas on how to describe or illustrate a topic in the video. The educator may wish to compare the different initial versions of the video to determine which version more effectively conveys the information. Thus, concurrent versions of the videos may be compared. Any number of versions may be compared. For example, two versions of videos may be compared, three versions of videos may be compared, four versions of videos may be compared, or more.

Any combination of newer and older versions and/or concurrent versions may be compared. For example, a user may wish to compare an older version of a video with two newer versions of a video provided as alternatives.

A comparison may be made with aid of A/B testing. A/B testing may be a form of split comparison testing. Different versions of the video may be shown to different users. For example, an educator may wish to compare two versions of a video. Half of the users may view a first version of the video and half of the users may view a second version of the video. For example, different users may visit the educator's site, or access an application of the educator. The users may be randomly selected to view the first version of the video or the second version of the video. In some instances, a random number generator may be used to aid in determining whether a user views the first version or the second version. In another example, users may be alternating selected to view different versions of the video (e.g., a first user may view a first version, a second user may view a second version, a third user may view the first version, a fourth user may view the second version, and so forth). A single user may only view a single version of the video.

In some embodiments, it may be desirable to compare the videos using a 50/50 split. For example, approximately half of the users may view a first version while approximately half of the users may view the second version. In other instances, an unequal split may be desired. For example, a 60/40 split may be provided where about 60% of the users view the first version and about 40% of the users view the second version. The educator or other individual running the comparison may dictate a desired split. For example, the educator and/or other individual may dictate a 10/90 split, 20/80 split, 30/70 split, 40/60 split, 45/55 split, 50/50 split, 55/45 split, 60/40 split, 70/30 split, 80/20 split, or 90/10 split.

The split may be determined based on the number of videos being compared simultaneously. If N number of videos are being simultaneously compared, it may be desirable to compare the videos using a 100/N split. Or any other split may be provided (e.g., for three videos, a 50/25/25 split may be provided, for four videos, a 20/20/30/30 split may be provided). The individual running the comparison may be able to dictate the split. Alternatively, a default split may be provided (e.g., an equal split).

FIG. 1 provides an example of a scenario where two users A and B are viewing different versions of the video. Each user may view their own user interface 110a, 110b. The users may be viewing the video simultaneously or at different points in time. The users may be at the same location or at different locations and may be viewing the video from over the Internet. The user interfaces may show the different versions of the video. User A may view a first version 120a of the video and user B may view a second version 120b of the video. The users may have been randomly assigned their version of the video. The users may optionally not be made aware that different videos exist. Both user A and user B may be presented with questions 130a, 130b pertaining to the video.

In some instances, the questions viewed by user A 130a may be the same as the questions 130b viewed by user B. Both sets of questions may have the same answer options. The questions may be worded identically or may have slight variations to wording. In some implementations, the slight changes in wording may not change the substance of the question but may change grammar based on the video. The questions may be presented before, during, and/or after the video is playing. The questions may be presented at roughly the same points in time relative to the video. Some variations in timing may occur due to the different versions of the video.

The questions may be laid over the video. The user answers to the questions may be recorded. User A's answers to the questions 130a may be recorded, along with user B's answers to the questions 130b. The results of the questions from all users viewing the different versions of the video may be analyzed and/or displayed. An educator may be able to view this data to determine whether video version 1 120a is more effective at conveying information than video version 2 120b, or vice versa, or whether the two versions are comparable.

Although two versions are provided by way of example, any number of video versions may be presented. Each of the video versions may be displayed along with corresponding questions. The corresponding questions may be substantially the same across the different versions.

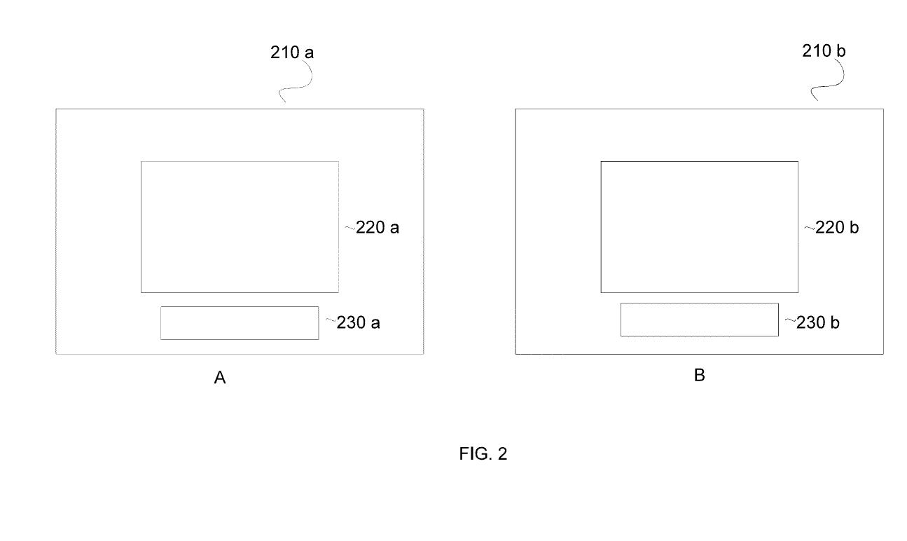

FIG. 2 shows another example of videos that may be displayed on different user interfaces. A first user interface 210a and a second user interface 210b may be provided. A first video 220a may be displayed in the first user interface, and a second video 220b may be displayed in the second user interface. At one or more points in time, a question 230a may be displayed in the first user interface, and a question 230b may be displayed in the second user interface.

In some instances, as illustrated in FIG. 1, the questions may be overlaid on the videos. In other examples, the questions 230a, 230b may be presented adjacent to the video 220a, 220b. For example, the questions may be displayed above the video, beneath the video, or to the side of the video. The video may or may not automatically be paused while the question is displayed. The questions may be displayed at desired points in time. For example, the questions may be displayed before the video, at different points during the video, or after the video has completed playing. Between the different versions of the video, the questions may be displayed at substantially corresponding times. There may be some variations in timing due to the variations in the video versions.

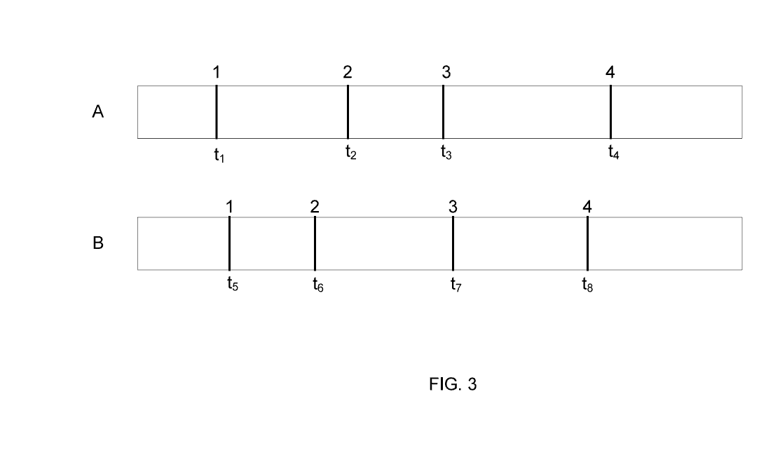

FIG. 3 shows examples of timelines indicating when questions may appear during a video's progress. In one example, different versions of videos may be presented to different users. Video A may be a first version of a video while video B may be a second version of the video. Video A and video B may or may not have the same length. Questions may be presented during the video pertaining to the content of the video or a topic covered by a video. The same questions may be presented for both video A and video B. For example, questions 1, 2, 3, and 4 may be presented during video A and video B.

However, since the versions of videos A and B may be slightly different, the questions may be presented at different points in time for video A and video B. For example, based on the content of the videos, it may be natural in video A to have question 1 presented earlier than in video B. For example, question 1 may pertain to a first topic discussed in videos A and B. Video B may spend more time discussing this topic, so question 1 pertaining to the same topic may be displayed later in time in the video.

An individual running a comparison of the videos, such as an educator, may be able to determine at what points in time the questions should be displayed in the videos. The educator may be able to formulate a single set of questions that may be displayed for both video versions. The educator may also then dictate when the questions should appear for each of the video versions. For example, for video A, question 1 may appear at time t₁, question 2 may appear at time t₂, question 3 may appear at time t₃, and question 4 may appear at time t₄. For video B, question 1 may appear at time t₅, question 2 may appear at time t₆, question 3 may appear at time t₇, and question 4 may appear at time t₈. In some embodiments, t₁ may be earlier than t₅, later than t₅, or the same time as t₅. Similarly, t₂ may be earlier than t₆, later than t₆, or the same time as t₆, and so forth.

The same number of questions may be displayed for videos A and B. For instance, one, two, three, four, five, six, seven, eight, nine, ten or more questions may be displayed for videos A and B. The questions may be overlaid on the videos. Alternatively, the questions may be presented adjacent to the videos or provided in a separate window or pop-up. The user responses to the questions may be gathered and stored in memory. The responses may include a selection of an answer or the user skipping the question. Information regarding whether the user viewed the question may also be stored. The responses to the questions may be analyzed with respect to the version of the videos with which they were displayed.

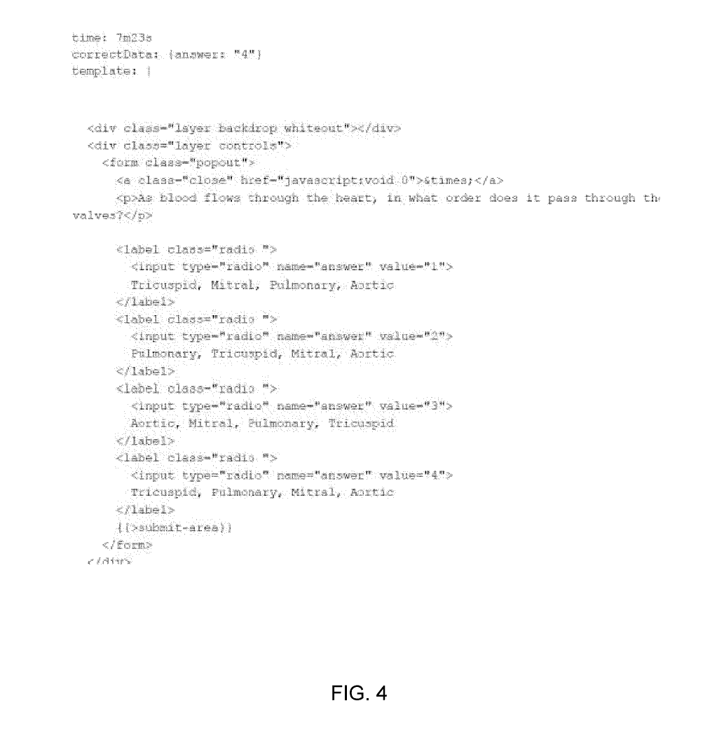

FIG. 4 shows an example of a configuration used to provide a question for a video. In some embodiments, videos may be streaming through a user interface. In some instances, embedded video players may be used to play videos on a site (e.g., YouTube video). In some instances, video creators may upload the different versions of the video to a video streaming site (such as YouTube) and input distinct identifiers (e.g., different YouTube IDs) for the videos. These distinct identifiers may be conveyed to a split testing tool (e.g., the A/B testing tool).

The identifiers for each video may be added to a configuration file. The configuration file may reside on a server for a content provider. For example, the content provider may be an educational website which may provide the videos and stream the videos through the website. The configuration file may specify which videos are to be included in a split testing comparison. Any number of videos may be compared (e.g., two videos, three videos, four videos, etc.). The configuration file may also specify how many students should see each video. For example, the configuration file may specify the ratio or breakdown of students that will see each video (e.g., 50%/50%). The configuration file may be altered to alter the ratio of students viewing each video. An example of a configuration is provided below:

FLOW_THRU_HEART = (

“7XaftdE_h60”: 50,
“G_UATd6NQPk”: 50,

)

In some implementations, an individual running the split test may alter the ratio by providing an input. The values from the input may be provided to the configuration file to control the ratio of the students viewing each video.

An individual running the test, such as an educator, may define the questions that will show up before, during, or after the videos. The questions may show up within the videos. The question configurations may be stored in any format, including but not limited to a YAML format. Each split test experiment may define a single set of questions that may be used with the multiple videos that are being compared.

The questions may be rendered as elements on top of the video player. The questions may be rendered in a website-compatible format, such as HyperText Markup Language (HTML) elements. Although HTML is provided by way of example, any other compatible markup language may be used (e.g., XML, XHTML, YAML), and vice versa. Each question may include one or more of the following components: (1) timestamp at which the question should be displayed, (2) question itself (e.g., as an HTML element), (3) answer choices (e.g., as HTML elements), (4) the correct answer value.

The timestamp at which the question should be displayed may be indicative of the time during the video's playback progress that the question should be displayed. For example, the question may be displayed 5 minutes and 34 seconds into the video, and the timestamp may be indicative of that time. The same question may be provided for different videos. The question for each video may have an individualized timestamp. For example, the question may be displayed 3 minutes into a first video, and the same question may be displayed 4 minutes into a second video. This may occur when videos are of different lengths, or have segments that are of different lengths. The questions may still need to be displayed in approximately the same location/segment of the video. The relative timings may be provided for alternative videos. For example, a question may be displayed at second 443 in a first video (e.g., control video) that is 470 seconds long and may be displayed at second 587 in a second video (e.g., alternative video or test video) that is 623 seconds long. The timestamps for the question may vary depending on the video. In some instances, a user may dictate the moments in time when the question may be displayed by entering a value for the timestamps for each video. In other instances, a user may dictate the moment by designating a timestamp for a first video, and the second video may automatically generate a timestamp based on variations in length of the video.

The questions, answer choices, and correct answer value may be the same between different videos. For example, the question wording, answer choices wording/order and correct answer value may be identical for the different videos. In some alternative embodiments, some slight variations may be provided.

FIG. 4 shows an example of a configuration used to provide a question. For example, the time that the question may be presented is entered as 7 minutes and 43 seconds. The question (“As blood flows through the heart, in what order does it pass through the valves?”) and answer choices are provided. The correct answer is also indicated as answer “4”. The resulting question may be rendered on top of the video that the student is watching.

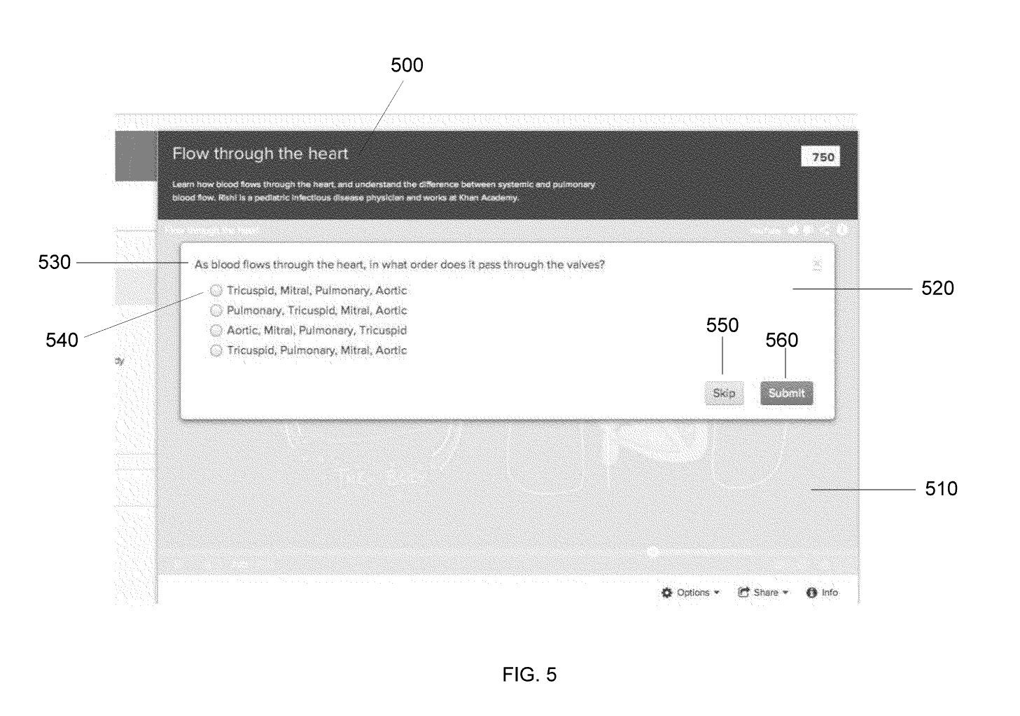

FIG. 5 shows an example of a question displayed on a user interface. The user interface may show a video 510. In some embodiments, additional information 500 may also be displayed. One or more question panel 520 may be displayed while the video is playing. The question panel may include a question 530 and one or more answer choices 540. The user may be able to select one or more of the answer choices. An option may be provided for the user to skip the question 550 or submit the user's answer 560 to the question.

A user interface may display information about content 500. The information about the content may include a subject or topic heading. For example, the content may pertain to “Flow through the heart.” Additional details about the content may be provided. In some instances, information about an educator may be provided. For example, if the user interface shows a video lecture, information about the lecturer may be provided. The additional information may include text, images, or other video.

A video 510 may be displayed on the user interface. In some embodiments, the video may include educational content about a topic. The video may include features, such as a progress bar that may show the video's progress. One or more playback controls may be provided (e.g., play, pause, stop, fast forward, rewind, or audio controls).

During the video, one or more questions may be presented to the user. In one example, the question may be presented in a question panel 520 that may overlay the video 510. In some instances, the underlying video may be paused while the question is displayed. Alternatively, the video may continue playing while the question panel is displayed. The underlying video, whether paused or playing, may be visible under the question panel. Alternatively, the video may be faded or greyed out, or may not be visible under the question panel. In some instances, the question panel may be positioned to be on top of the video. In alternative embodiments, the question panel may be above the video, beneath the video, or adjacent to the video. The question may or may not partially or completely be on the video. A single question panel may be displayed at a time. Alternatively, multiple question panels may be displayed at one or more points in time. The display of a question panel may be registered by the system.

The question panel 520 may include a question 530 and one or more answer choices 540. In some instances, the question may be a multiple choice question. A plurality of answer choices may be presented. In some instances a user may only be able to select a single answer choice from the plurality of answer choices. In some other instances, a user may select one or multiple answer choices from the plurality of answer choices. After the user has made his or her selection, the user may select an option to submit the answer 560. The user may be able to change the user's answer until the user selects submit. The system may register which answer(s) has been submitted by the user.

The question panel may also provide an option for the user to skip the question 550. The user's selection to skip the question may be registered by the system.

In some instances, the question may remain displayed until the user selects an option to skip the question or submit an answer. In other instances, the question may remain displayed for a predetermined amount of time. If the answer does not submit an answer within the predetermined period of time, the question panel may be removed and the video may continue playing. The user may be deemed to have skipped the question if the user does not submit an answer in the predetermined period of time.

When a user, such as a student, visits a site, such as an educational website, that displays the video, the system may randomly select the video for the student to view from a plurality of options. For example, four different versions of the video for a particular topic may be provided for split testing. The system may randomly select one of the four different versions for the user to view. When a user is logged into the site, the video that is chosen for the user may be stored in his or her account, or an identifier associated with the chosen video may be stored in the user's account. For example, if a user watched a Version 2 of a video, the user's account may store an indicator that the user watched Version 2, so that when the user returns to the site, the user may access Version 2. In subsequent visits to the site, the same video that the user watched may be rendered. Thus, the user may be able to rewatch the same video. For users who do not have an account, the selected video or identifier for selected video may be stored as a cookie in the user's browser so that subsequent visits to the page can render the same video.

While a user is watching a video, and the video encounters a timestamp configured to show a question, the video may be paused. The question may be displayed, e.g., as shown in FIG. 5. The event may be logged into the system's database as a “question shown” event. Thus, a record may be made whenever a question is shown. The user may answer the question or skip the question. In some instances, the user may have only one opportunity to answer the question. In other instances, the user may answer the question as many times as needed to get the answer correct. In some instances, only the first answer may be logged. In some instances, if a user has the option of answering the question multiple times until correct, each answer may be logged, or the number of times the user attempts to answer the question before getting it correct may be logged. In some instances, “question correct”, “question incorrect” and/or “question skipped” events may be logged. Optionally, number of “question answer attempt” until the user gets the answer correct may be logged.

The system may aggregate events that have been logged. The data from the video playback, such as user interaction with questions, may be stored in memory. The memory may be one or more databases. Any description of databases may apply to any type of memory storage system and vice versa. In some instances, the memory may be stored in a cloud-computing infrastructure. The memory may be stored in a memory of one or more servers.

The data may be broken down by video. For example, for each video version shown, data may be aggregated and presented. In some instances, sums may be broken down by participants and conversions for each of the videos.

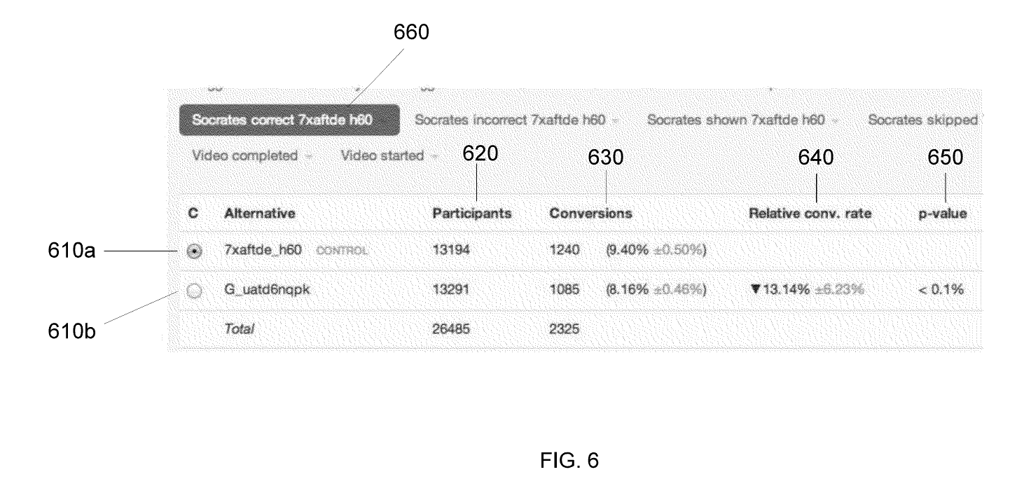

FIG. 6 shows an example of data that may be collected and/or analyzed regarding responses to questions displayed with a video. The data may be broken down by the different videos 610a, 610b that were shown. In some instances, a first video 610a may be a control while the other videos may be alternatives. In some instances, a control video may be an initial version of a video while the alternatives may be variations to the initial version (e.g., made in response to feedback or made concurrently). Any video may be selected as the control video. An identifier associated with each video may be displayed. In some instances, the identifier may be a video identifier used with a video playback system (e.g., YouTube).

The number of participants 620 may be displayed. The number of participants may be broken down for each video. For example, the first video may have 13194 participants, while the second video may have 13291 participants (e.g., individuals who viewed the video). The number of participant data may be accessed from one or more databases.

The conversions 630 may be displayed. The conversions may be the number of correct answers. The number of conversions may be broken down for each video. For example, the first video may have 1240 conversions while the second video may have 1085 conversions. For the first video, 1240 correct answers may be submitted from 13194 students, while for the second video 1085 answers may be submitted from 13291 students. This may mean that in the first video, the students submitted 1240 correct answers to the embedded questions, while for the second video, the students submitted 1085 correct answers to the embedded questions. The conversions may be provided as numerical values and/or relative values such as percentages. For example, the conversions for the first video may be about 9.4% while the conversions for the second video may be about 8.16%. These may be ratios of correct answers per student. The conversion data may be accessed from one or more databases. In some instances, the conversions may be low when few questions are provided, and/or are provided near the end of the video. Many students may have navigated away from the video by this point, but may still be considered participants. Factors, such as number of students that started watching the video, finished watching the video, were presented with the question, answered the question, or skipped question may be factored into analyzing the data, as described elsewhere herein.

The relative conversion rates 640 may be calculated and/or displayed. The relative conversion rates may be calculated with aid of a processor. The relative conversion rates may compare the conversions between a first video and a second video. For example, if the first video is a control, then the conversion rate of the second video relative to the first video may be calculated. In some instances, any number of videos may be compared. A video may be selected as the control. The conversions of each of the other videos may be compared relative to the control video. In one example, the conversion percentage for the second video may be lower than the conversion percentage for the first video. Thus, the conversion rate of the second video relative to the first (control) video may be negative. It may be shown that the conversion rate dropped by 13.14%. When the conversion rate is dropped, an individual assessing the data may determine that the second version of the video is not as effective as the first video in conveying information. For example, if the rate of answering questions correctly drops from the first video to the second video, the second video may be less effective, and the educator may wish to go with the first video. In another example, if the rate of answering questions correctly increases from the first video to the second video, the second video may be more effective, and the educator may wish to go with the second video. Additional data may be displayed which may affect the educator's assessment of whether the first or second video is more effective. Multiple factors may be weighed in making the determination. When multiple versions of videos are simultaneously compared, an educator may wish to select a version of the video that has the highest conversion rate. Optionally, the educator may select a version based on multiple factors.

Statistical data, such as a p-value 650 for the relative conversion rate may be displayed. The p-value may be indicative of the probability of obtaining a test statistic at least as extreme as the one observed assuming a null hypothesis is true. Any other types of statistical analysis may be employed in comparing the aggregated data.

The data may be displayed as numerical values. The data may be displayed so that data corresponding to each video is visually mapped. For example, data for the same video may be displayed in the same row or the same column. In alternative embodiments, the data may be displayed in any other form, such as graphical representations (e.g., line graphs, pie charts, bar graphs, pictographs, etc.).

Different categories 660 of data may be displayed. For example, the categories may include questions answered correctly, questions answered incorrectly, questions shown, questions skipped, video completed, and/or video started. In FIG. 6 “questions answered correctly” data may be selected and displayed. In some instances, the aggregate total for all of the questions displayed with the video may be analyzed and/or displayed. In some instances, the data may be broken down on a question by question basis. For example, number of correct answers, incorrect answers, questions shown, and/or questions skipped may be broken down on a question by question basis. This may permit an educator to view the data and analyze how effectively each video is teaching certain topics. For example, a first question may pertain to segment A of a video and a second question may pertain to segment B of a video. In some instances, a first video may have a higher percentage of correct answers for segment A while a second video may have a higher percentage of correct answers for segment B. This data may be useful to the educator, and may be an indication that the educator may want to use segment A of the first video and combine it with segment B of the second video to create a more effective video.

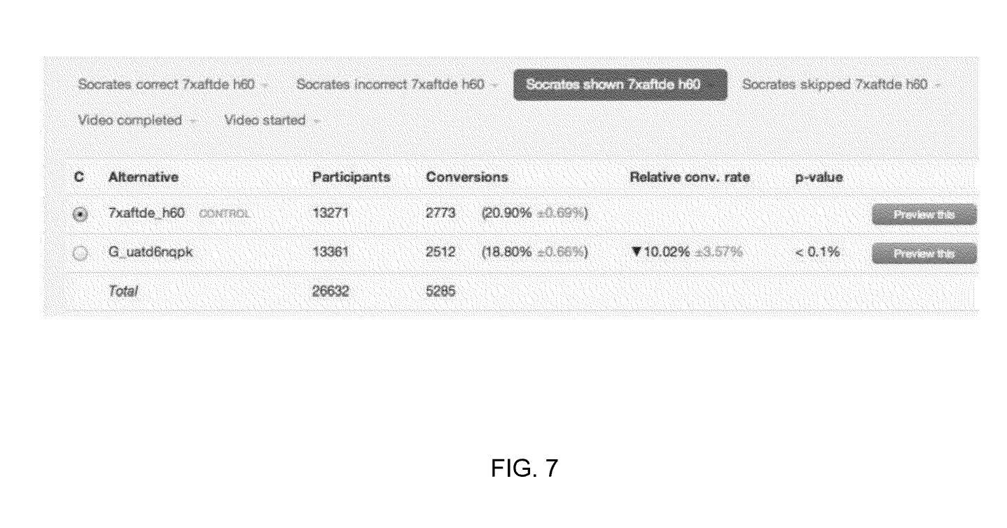

FIG. 7 shows another example of data that may be collected and/or analyzed regarding responses to questions displayed with a video. For example, a category for questions shown may be selected. The data may be broken down by video, similar to FIG. 6.

The data may be displayed to an educator. The educator may view the data and perform a higher level analysis. For example, although FIG. 6 makes it seem that the second video delivered a lower correct answer per student count, FIG. 7 shows information about the count of the questions that were actually shown. The second video showed fewer questions. This may be because the second video was longer in length and the questions were displayed at the end, so more students stopped watching the video before the questions have a chance to be asked. The educator may take all this data into account when considering different versions of the video to select.

Alternatively, a processor may be able to provide further analysis, such as make a recommendation for a video version to be selected. In some instances, a processor may automatically select a “winning” video to have conveyed the information most effectively. This may be based on multiple factors, such as data shown in FIG. 6 and FIG. 7. The processor may weigh different factors and make an assessment of the videos. This may be based on the totality of the questions presented during the video. In other instances, the processor may recommend different segments from different videos that may have conveyed certain topics most effectively, based on a question by question analysis.

The analysis may include a recommendation for a video version or video segment version to be selected based on the number of correct responses, or a percentage of correct responses. A higher number or percentage of correct responses may lead a recommendation of the video version or segment with the higher number or percentage. The analysis may recommend a video version or video segment version based on the number or percentage of incorrect responses. A lower number or percentage of incorrect responses may lead to a recommendation of the video version or segment with the lower number or percentage. The analysis may recommend a video version or video segment based on a number or percentage of questions completed. A higher number or percentage of questions answered may lead to a recommendation of the video version or segment with the higher number or percentage. The analysis may recommend a video version or video segment based on how much of a video the user finishes watching. A higher video completion rate may lead to a recommendation of the video version or segment with the higher completion rate. Any factors described herein may be used alone or in combination. Any of the data may be normalized against a pre-video set of questions that established a user's knowledge before watching the video. An indication of the recommended video or video segment may be displayed to be viewed by a user. A reason for the selection of the video or video segment may be displayed to the user (e.g., factors that were weighed in considering the selection of the video or video segment).

In some embodiments, follow-up questions may be provided to determine long-term retention of the information conveyed in the videos. For example, in addition to, or in the place of, questions that are asked right before, during, or after the video, follow-up questions may be asked at a later period of time. The follow-up questions may pertain to the content of the video. In some instances, the follow-up questions may be presented after a period of time (e.g., 1 day, several days, 1 week, 2 weeks, 3 weeks, 1 month, 1 quarter, 1 year).

The user responses to the questions may be analyzed, similar to how the questions displayed with the video may be analyzed. For example, the number of participants, correct answers, incorrect answers, questions shown, questions skipped may be analyzed for the follow-up questions displayed after the user watched the video. A split comparison test may be performed using the follow-up question results as an indication of how well viewers retained knowledge from the video.

In some embodiments, information about videos viewed by the user may be stored in memory and associated with a user account. When the user logs into the user's account after a predetermined period of time, the user may be automatically presented with an option to answer the follow-up questions.

In some implementations, a single set of questions may be presented for the different videos that are being compared. The single set of questions may be displayed with the video or presented as follow-up questions. In some instances, the single set of questions may be a relatively small set of questions presented by the educator so as to not overwhelm a student and detract from the video itself.

In some other implementations, a larger bank of questions may be created. The system may pick a subset of the questions to display in relation to the video (e.g., during the video or follow-up question a time period after the video). Optionally, different questions (e.g., displayed with the video or follow-up questions) may be presented for the different videos. For example, a bank of 50 question may be created. The system may randomly select a subset of the question (e.g., 3 questions) to display to each student. In some instances, the educator may create a desired number of questions to go into the bank. The educator may also dictate the number of questions to be presented to each student. In some instances, each student may be presented with the same number of questions. Alternatively, there may be variation to the number of questions presented to each student. The questions presented may be randomly selected from the bank. Alternatively, there may be some parameters with which the questions may comply with for being selected. For example, certain questions in the banks may be related to certain subtopics to be shown in the video. The questions may be selected for which the subtopics to which the questions pertain have already been shown in the video. For example, if video covers subtopics A, B, and C, if a question is presented after subtopic A but before B and C, only questions pertaining to subtopic A may be selected from the bank to be displayed. In another example, if the question is presented at the end of the video after subtopics A, B, and C have been displayed, any of the questions from the banks pertaining to any of A, B, and C may be displayed.

By permitting a larger bank of questions, an educator may be able to understand much more about how each of the videos is teaching each aspect of the topic/concept. When a large bank of questions is used, the results may be analyzed for the videos on a per-video basis, or may be analyzed on a per-video and per-question basis.

In some embodiments, each user (e.g., participant/student viewing the video) may have an account that the system can use to determine which video the user sees and properly organize their answers to the in-video questions. The system may track which video has been seen and may permit the user to re-access the video that was seen without permitting the user to view any of the comparison videos. The system may maintain control over which videos for a particular topic are seen by a user. In one example, a user may be at an educational website and may select an option to view a video for a particular topic, Topic 1. The user may be randomly assigned a video for that particular topic. For example, Video 1, Video 2, and Video 3 may be different versions of videos about Topic 1. The user may be assigned Video 3. A record may be created that the user was assigned Video 3, and any time the user attempts to view a video for Topic 1, the user may be shown Video 3. The user may not be made aware that other video versions are in existence. The system may also keep track of questions in view of which video the user was assigned. The system may track which follow-up questions to present in view of which video the user was assigned.

The videos may be shown on a site in the context of an online educational community. One or more educators may create and/or upload videos to the educational community. One or more students may view the uploaded videos on the educational community. The educational community may have an organizational structure that may permit videos to be organized by topics and/or subtopics. In some instances, the videos may be organized by classroom subject. A website may display a library of videos in a well-organized taxonomy.

The online educational community may track which videos a user has watched and/or uploaded. The online community may or may not keep track of the number of times a user has viewed a video. The online community may optionally track whether the user has started and/or completed the video, or whether the user has viewed up to one or more checkpoints during the video. Online community may also keep track of data pertaining to questions shown to a user and user response to the questions. In some instances, a user may be able to earn points by performing one or more action in the online community. For example, watching a video may earn a viewer energy points. In some instances answering questions may also earn a viewer energy points. Answering questions correctly may or may not early a user more points than answering a question incorrectly or skipping the question. A user may aggregate a number of points from different activities in the online community. A user may also receive virtual achievements or awards for different activities. The achievements or awards may be earned through watching videos and/or answering questions.

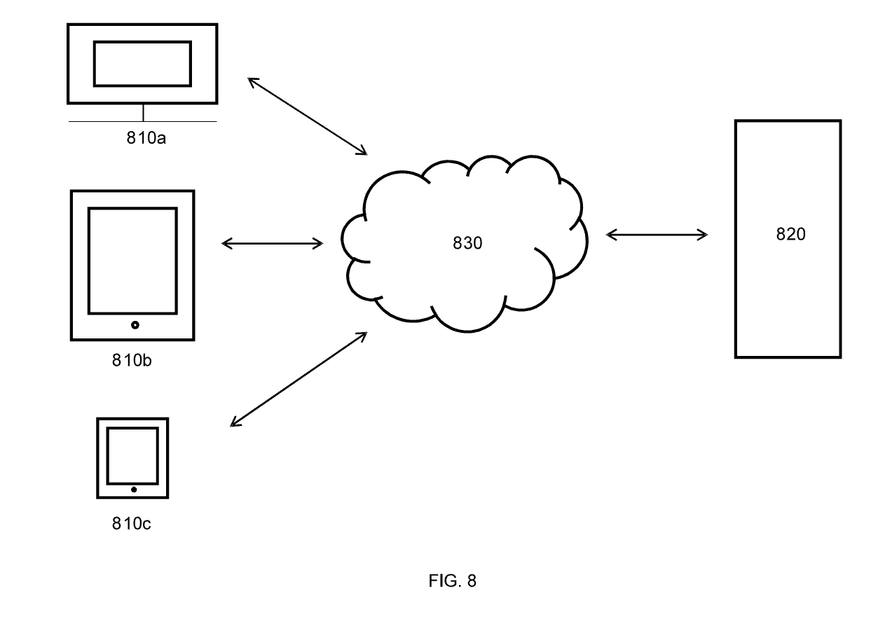

FIG. 8 shows a system for a providing a video in accordance with an embodiment of the invention. The system may provide an educational community which may provide informative videos about one or more topics.

One or more devices 810a, 810b, 810c may be in communication with one or more servers 820 of the educational community system over a network 830.

One or more user may be capable of interacting with the system via a device 810a, 810b, 810c. In some embodiments, the user may be a student or individual learning a topic through the online educational community. The user may be an educator. The user may be an educator teaching one or more individuals through the online community. The user may be an administrator of the online community. The user may create one or more videos. The user may be a lecturer shown in one or more videos. The user may view one or more videos and/or respond to questions pertaining to the one or more videos.

The device may be a computer 810a, server, laptop, or mobile device (e.g., tablet 810c, smartphone 810b, cell phone, personal digital assistant) or any other type of device. The device may be a networked device. Any combination of devices may communicate within the system. The device may have a memory, processor, and/or display. The memory may be capable of storing persistent and/or transient data. One or more databases may be employed. Those persistent and/or transient data may be stored in the cloud. Non-transitory computer readable media containing code, logic, or instructions for one or more steps described herein may be stored in memory. The processor may be capable of carrying out one or more steps described herein. For example, the processor may be capable of carrying out one or more steps in accordance with the non-transitory computer readable media.

A display may show data and/or permit user interaction. For example, the display may include a screen, such as a touchscreen, through which the user may be able to view content, such as a user interface for an educational community. The user may be able to view a browser or application on the display. The browser or application may provide access to the online community. The user may be able to view a video via the display. The video may show educational content. One or more questions may be displayed on the user interface before, during, or after the video. The display may be capable of displaying images (e.g., still or video), or text. The device may be capable of providing audio content.

The device may receive user input via any user input device. Examples of user input devices may include, but are not limited to, mouse, keyboard, joystick, trackball, touchpad, touchscreen, microphone, camera, motion sensor, optical sensor, or infrared sensor. Any type of user input may be provided via the user input device, such as a request for a video, or a response to a question.

The device 810a, 810b, 810c may be capable of communicating with a server 820. Any description of a server may apply to one or more servers and/or databases which may store and/or access content and/or analysis of content. The server may be able to store and/or access data for an online educational community. The data may include information about different video versions that were shown (e.g., started, completed), number of participants, number of questions shown, numbers of questions answered or skipped, number of correct answers and/or numbers of incorrect answers, or number of times a user attempts to answer a question. The data may include tallies of user response types, in one or more categories, such as number of correct user response, number of incorrect user responses, number of skipped questions, or number of questions that have timed out. The data may also include different versions of the videos and information about which users viewed which versions of the videos. The data may further include one or more sets of questions to be displayed with the videos and/or a bank of questions from which the questions may be selected. The server may be able to access user account information for an online community. The one or more servers may include a memory and/or programmable processor.

A plurality of devices may communicate with the one or more servers. Such communications may be serial and/or simultaneous. For examples, many individuals may participate in an online community simultaneously. The individuals may be able to interact with their respective videos and/or provide answers to questions. In some embodiments, a first individual on a first device 810a may view a first version of video and answer related questions, while a second individual on a second device 810b may view a second version of the video and answer related questions.

The server may store information about users of the online community. In some instances, registered members of the online community may have accounts. The account information may be stored in memory accessible by the server. For example, information such as the user's name, contact information (e.g., physical address, email address, telephone number, instant messaging handle), educational information, work information, social information, historical information, or other information may be stored. The user account information may be linked to videos that have been viewed or created by the user.

The programmable processor of the server may execute one or more steps as provided therein. Any actions or steps described herein may be performed with the aid of a programmable processor. Human intervention may not be required in automated steps. The programmable processor may be useful for analyzing code and/or generating an output. The server may also include memory comprising non-transitory computer readable media with code, logic, instructions for executing one or more of the steps provided herein. For example, the server(s) may be utilized to permit a user to create or upload a video and/or create or upload one or more questions relating to the video. The user may select times the questions should be displayed for each video. The server(s) may be utilized to permit a user to view a video and/or respond to one or more questions relating to the view. The server(s) may aggregate data relating to multiple users' responses to the questions for the videos. Analysis may occur with aid of the processor. The data may be stored in memory (e.g., databases or other memory storage units). The server(s) may access such information when displaying the data in an organized fashion.

The device 810a, 810b, 810c may communicate with the server 820 via a network 830, such as a wide area network (e.g., the Internet), a local area network, or telecommunications network (e.g., cellular phone network or data network). Communication may also be intermediated by a third party.

In one example, a user may be interacting with the server via an application or website. For example, a browser may be displayed on the user's device. For example, the user may be viewing a user interface for an online educational community via the user's device. The user may view, create, or upload a video and/or questions via the user's device. The video and/or embedded questions may play on the user's device video and/or audio display.

Aspects of the systems and methods provided herein, such as the devices 810a, 810b, 810c or the server 820, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

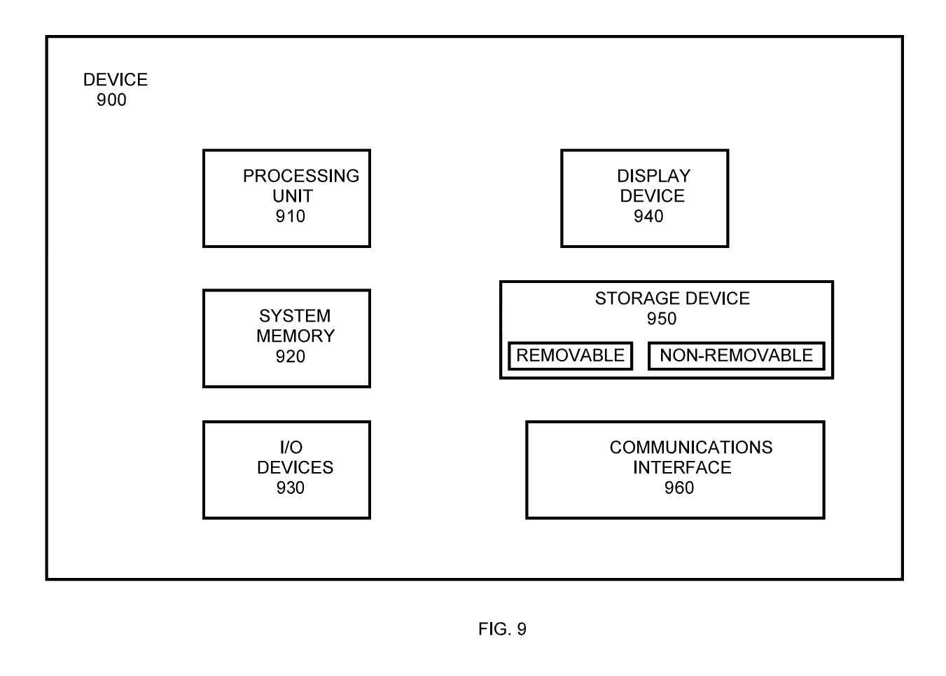

FIG. 9 shows an example of a computing device 900 in accordance with an embodiment of the invention. The device may have one or more processing unit 910 capable of executing one or more step described herein. The processing unit may be a programmable processor. The processor may execute computer readable instructions. A system memory 920 may also be provided. A storage device 950 may also be provided. The system memory and/or storage device may store data. In some instances the system memory and/or storage device may store non-transitory computer readable media. A storage device may include removable and/or non-removable memory.

An input/output device 930 may be provided. In one example, a user interactive device, such as those described elsewhere herein may be provided. A user may interact with the device via the input/output device. A user may be able to view a video and/or answer questions by using the user interactive device.

In some embodiments, the computing device may include a display 940. The display may include a screen. The screen may or may not be a touch-sensitive screen. In some instances, the display may be a capacitive or resistive touch display, or a head-mountable display. The display may show a user interface, such as a graphical user interface (GUI), such as those described elsewhere herein. A user may be able to upload or view a video or related questions through the user interface. In some instances the user interface may be a web-based user interface.

A communication interface 960 may also be provided for a device. For example, a device may communicate with another device. The device may communicate directly with another device or over a network. In some instances, the device may communicate with a server over a network. The communication device may permit the device to communicate with external devices.

The systems and methods described herein may utilize or be combined with aspects, components, characteristics, steps, or features of one or more of the following: U.S. Patent Publication No. 2013/0275156 published Oct. 17, 2013; PCT Publication No. WO 2013/059798 published Apr. 25, 2013; U.S. Pat. No. 8,296,643 issued Oct. 23, 2012; and U.S. Patent Publication No. 2012/0239537 published Sep. 20, 2012, which are hereby incorporated by reference in their entirety.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A method for comparing online educational videos, said method comprising:
storing, in a memory, a first video about a topic including at least one question relating to content of the first video and a second video about the same topic including at least one question relating to content of the second video;
receiving a first request for a video to be displayed on a first user interface and a second request for a video to be displayed on a second user interface;
providing, in response to the first request, the first video, and providing, in response to the second request, the second video;
receiving, information about a user response to the at least one question relating to the content of the first video and information about a user response to the at least one question relating to the content of the second video; and
displaying, with aid of a processor, an analysis of the information about the user response to the at least one question relating to the content of the first video and the information about the user response to the at least one question relating to the content of the second video, thereby aiding in a determination of whether the first video conveys the topic more effectively or the second video conveys the topic more effectively.

2. The method of claim 1 wherein the first user interface is shown on a display of a first user device and wherein the second user interface is shown on a display of a second user device.

3. The method of claim 2 wherein the analysis of the information is shown on a display of a third user device that is different from the first user device and the second user device.

4. The method of claim 3 wherein the display of the third user device is configured to be viewed by an individual who is a creator of the first video and the second video.

5. The method of claim 1 wherein the user response to the at least one question relating to the content of the first video is received before completion of playback of the first video, and wherein the user response to the at least one question relating to the content of the second video is received before completion of playback of the second video.

6. The method of claim 1 wherein the user response analyzed as belonging to one or more of the following categories: a correct user response, an incorrect user response, a skipped question, or a timed out question.

7. The method of claim 1 wherein the at least one question relating to the content of the first video is the same as the at least one question relating to the content of the second video.

8. The method of claim 7 wherein the at least one question relating to the content of the first video is presented at the same point in a playback of the first video as the at least one question relating to the content of the second video during playback of the second video.

9. The method of claim 7 wherein the at least one question relating to the content of the first video is presented at a different point in a playback of the first video as the at least one question relating to content of the second video during playback of the second video.

10. The method of claim 1 wherein the first video and the second video include an instructor speaking on the topic with one or more visual aids.

11. The method of claim 1 further comprising receiving information about a user response to at least one pre-video question relating to, and presented prior to starting playback of, the content of the first video and information about a user response to at least one pre-video question relating to, and presented prior to starting playback of, the content of the second video, thereby assessing a baseline of the user's knowledge.

12. The method of claim 1 wherein the at least one question relating to the content of the first video is presented in a first question panel overlaying the first video, wherein the first question panel includes one or more answer choices to the question, and the at least one question relating to the content of the second video is presented in a second question panel overlaying the second video, wherein the second question panel includes one or more answer choices to the question.

13. The method of claim 1 wherein the analysis of the information includes a tally of a number of participants that viewed the first video and a number of participants that viewed the second video.

14. The method of claim 15 wherein the analysis of the information includes a number of participants that answered the at least one question relating to the content of the first video correctly and a number of participants that answered that at least one question relating to the content of the second video correctly.

15. A system for comparing online educational videos, said system comprising:
a memory configured to store a first video about a topic including at least one question relating to content of the first video and a second video about the same topic including at least one question relating to content of the second video; and
one or more processors individually or collectively configured to:
receive a first request for a video to be displayed on a first user interface and a second request for a video to be displayed on a second user interface;
generate, in response to the first request, an instruction to provide the first video, and provide, in response to the second request, an instruction to provide the second video;
receive, information about a user response to the at least one question relating to the content of the first video and information about a user response to the at least one question relating to the content of the second video;
analyze the information about the user response to the at least one question relating to the content of the first video and the information about the user response to the at least one question relating to the content of the second video; and
generate an instruction to show, on a display, the analysis of the information, thereby aiding in a determination of whether the first video conveys the topic more effectively or the second video conveys the topic more effectively.

16. The system of claim 15 wherein the first video is played on a display with aid of a web browser, and wherein the second video is played on a display with aid of a web browser.

17. The system of claim 16 wherein the at least one question relating to the content of the first video is rendered in a website-compatible format, and the at least one question relating to the content of the second video is rendered in a website-compatible format.

18. The system of claim 15 wherein the memory stores information about user responses to multiple questions relating to the content of the first video and information about user responses to multiple questions relating to the content of the second video.

19. The system of claim 18 wherein the analysis of the information includes determining percentages of correct answers to the questions by participants on a question by question basis for the multiple questions relating to the content of the first video and the multiple questions relating to content of the second video.

20. The system of claim 15 wherein the analysis of the information includes determining a number of participants that complete watching the first video and a number of participants that complete watching the second video.
